(19) United States
(12) Patent Application Publication
(10) Pub. No.: US 2006/0177018 A1
(43) Pub. Date: Aug. 10, 2006

(54) Coherent interleaved sampling

(75) Inventors: Kensuke Kobayashi, Airmont, NY (US); Stephen Ems, Sloatsburg, NY (US); John DeMott, Stewartsville, NJ (US); Michael Schnecker, Doylestown, PA (US)

Correspondence Address: LECROY CORPORATION, 700 CHESTNUT RIDGE ROAD, CHESTNUT RIDGE, NY, 10977, US

(73) Assignee: LeCroy Corporation, Chesnut Ridge, NY (US)

(21) Appl. No.: 11/346,854

(22) Filed: Feb. 3, 2006

Related U.S. Application Data
(60) Provisional application No. 60/650,985, filed on Feb. 7, 2005.
(60) Provisional application No. 60/656,203, filed on Feb. 25, 2005.

(51) Int. Cl. H04M 1/64

(52) U.S. Cl. 379/88.07

(57) ABSTRACT

A method and apparatus for digitizing a repetitive signal having a long pattern length is provided. The method comprises the steps of determining a clock period to be used when sampling the repetitive signal and determining a frame period of the repetitive signal. Thereafter, a sampling period is selected that is a relatively prime integer when compared with the clock period and frame period. The sampling period also comprises an integer number of time resolution periods, so that when sampling is performed in accordance with the sampling period, all time resolution periods are sampled at a same relative time position thereof.

### CROSS REFERENCE TO RELATED APPLICATIONS

This application claims the benefit of US Provisional Patent Application Ser. Non. 60/650,985, entitled “Sampling Scope”, filed Feb. 7, 2005, and US Provisional Patent Application Ser. No. 60/656,203, entitled “Coherent Interleaved Sampling”, filed Feb. 25, 2005.

### BACKGROUND OF THE INVENTION

While the speed of oscilloscopes has increased substantially in recent times, the speed of signals that are to be viewed by the scopes has also increased substantially. Indeed, the speed of many signals now outstrips the ability for physical hardware to keep up and properly sample and digitize the signal. In order to acquire signals that are faster than any hardware is capable of sampling, a sampling oscilloscope has been developed. In such a sampling oscilloscope, a number of samples of a repetitive waveform are taken on each of a plurality of consecutively presented waveforms. If these samples are taken at different times on each of the plurality of waveforms relative to a defined starting point thereof, they can be used together to presented a reconstructed representation of the entire waveform.

While a number of attempts have been made to provide such a sampling system, each of these attempts includes drawbacks when looking at a signal having a long repeat period, such as a Pseudo-Random Bit Stream (PRBS) used in conjunction with communications equipment, or the like. U.S. Pat. No. 6,271,773 titled “Coherent sampling method and apparatus”, issued in 2001 to Kobayashi (one of the inventors of the present invention), discloses a coherent sampling method for fast data acquisition for simple periodic signals. While the '773 patent describes the acquisition of a random bit stream over a short time range (i.e. having a short repeat period), it does not allow for the acquisition of a long bit sequence having a long repeat period, such as a PRBS use in the communication industry. Other conventional equivalent sampling oscilloscopes employing conventional methods cannot measure such a long signal having a long repeat period, such as a PRBS signal without the use of a frame (pattern) trigger signal. Such prior art systems and methods include the following.

U.S. Pat. Nos. 5,162,723, titled “Sampling Signal Analyzer”issued in 1992 to Marzalek, et al., 4,928,251, titled “Method and Apparatus for Waveform Reconstruction for Sampled Data System” issued in 1990 to Marzalek, et al., and the '773 patent (noted above) all propose different coherent sampling methods. The methods used in the '723 and '251 patents have a very specific constraint between input frequency and sampling rate, such that the sampled output (i.e. IF) is a time-stretched replica of the input signal. In order to acquire a long waveform having a long repeat period such as a PRBS waveform, by such a method, a pattern (frame) repetition rate of the PRBS must be used as an input signal frequency. However the following issue arises. Because of this constraint, the method requires that a signal frequency should be higher than a sampling rate, as is discussed in the HP journal, Oct. 1992, pp71. Otherwise acquired data has to be decimated. For example, if a typical PRBS has a 10 Gbps pattern length of (2²³−1), then the signal frequency (i.e. pattern repetition rate in this case) is almost 1.2 KHz. At such a pattern repetition rate, this method discards approximately 99.99% of the acquired data and uses only approximately 0.012% (1.2 KHz/10 MHz) of the data to construct a replica of the PRBS signal. As a result, it would take approximately 7 K seconds (2 hours) to acquire only one data per each bit, which is not practical.

On the other hand, by using about a 10 MHz sample rate, the method described in the '773 patent seems to be able to acquire data within 0.84 sec (=(2²³−1)/10 MHz). However the '773's targeted signal is a simple periodic one, there is no description about how to get the optimum sampling clock rate for a more complicated signal, such as a PRBS signal.

In addition to these sampling rate issues, sampling accuracy issues may present difficulties when employing these methods. Each of the above patents measures input signal frequency using a sampling clock, so that the employed sampling clock frequency must be known a priori and precisely by the various measurement instruments. For example, to keep 1 picosecond time accuracy during such a measurement, the stability of a sampling clock having a frequency of about 10 MHz should be 1.2*10⁻¹¹ for the '773 patent, and 1.5*10⁻¹⁵ for the '723 and '251 patents. These stabilities correspond to 0.1 MHz and 0.015 uHz respectively, stabilities that have been traditionally hard to realize with conventional electronic parts.

U.S. Pat. No. 6,374,388, titled “Equivalent Capture Scheme for Bit Patterns within High Data Rate Signals” issued in 2002 to Hinch uses a specific pattern recognizer to generate a pattern trigger for its sequential sampling method. However for acquiring a waveform around a trigger time position, a PRBS signal has to be delayed by at least a “minimum delay time” (around 20 ns or more) of the sequential sampling oscilloscope. This delay required by the oscilloscope reduces bandwidth of the measurement system to below a few GHz, which is too low for a long high rate measurement, such as when measuring a PRBS or other long repeat length signal.

U.S. Pat. No. 6,181,267 describes a sub-harmonic sampling system including a “quality optimizer” system specifically for measuring and compensating for clock rate errors in an applied signal. While a trigger system is described, only data rate synchronization is described. There is no reference to a pattern rate synchronization.

Thus, the prior art sampling techniques, and subsequent collection of data and display of a waveform, have a number of difficulties.

### SUMMARY OF THE INVENTION

The present invention is particularly concerned with a digital storage oscilloscope (DSO) employing a coherent sampling method. While a coherent sampling method has been disclosed in at least U.S. Pat. No. 6,271,773 (as noted above), it has been determined by the invention or the present invention that the coherent sampling method employed in the '773 patent is only able to acquire a simple repetitive waveform very quickly with fine time resolution by determining an optimum sampling rate based on signal frequency, but is not able to acquires a long, complicated signal, such as a PRBS signal. Therefore, one object of the invention is to provide a system that overcomes the drawbacks of the prior art. A further object of the invention is to provide an improved method and apparatus to acquire a waveform including a PRBS sequence. Still another object of the invention is to provide an improved method and apparatus for determining an appropriate sample rate, and to allow for PRBS measurement by equivalent time sampling without the need for a pattern (frame) trigger. Another object of the invention is to acquire a complete signal including a PRBS uniformly in time (i.e. with a constant time resolution), and allowing for post processing.

Therefore, through the unique combination of the application number theory and innovative circuit design, the CIS system in accordance with the invention overcomes many limitations of a sampling oscilloscope when the oscilloscope is used to analyze signals, such as PRBS patterns, that are random in the short term but repetitive in the long term.

As noted above, a sampling oscilloscope is only useful for analyzing repetitive waveforms. A sine wave or square wave at a specific, fixed frequency is an example of a repetitive waveform. There are other types of waveforms that repeat over a longer period but are non-repetitive over a short period. A Pseudo Random Bit Sequence (PRBS) waveform repeats at a frame rate but is non-repeating in each bit period. A video signal with a static test pattern displayed is another example of a signal that repeats over a long period but is non-repetitive in the short term. The CIS system of the invention is most useful for analyzing this class of waveforms, but can be used for any number of waveforms.

PRBS waveforms are signals used extensively in data communications testing. Such a waveform is typically an NRZ data stream of random “1”s and “0”s that repeats after a specified number of bits. For example, a PRBS of 2⁷−1 would generate a string of 127 “1”s and “0”s and then repeat the same sequence. Therefore, such a signal has two “periods” associated with it . . . a bit period and a frame period. The bit period is the time to transmit one bit and the frame period is the time to transmit 127 bits in the previous example. The CIS system of the invention allows simultaneous synchronization to the bit period and the frame period so there are always a precise, known number of samples in each bit period AND in each frame period. This enables types of analysis that are not possible with other techniques. For example, bit error identification, ISI plots, etc.

The CIS system of the invention relies upon a “clock” or periodic input in addition to the signal of interest. The system synchronizes the sample clock of the digitizing system to this clock input in such a way as to ensure a precise integer number of samples of the input signal will be collected in each clock period and at the same time will be synchronized with the frame period. Therefore, in accordance with the invention, the CIS system is able to synchronize a sampling signal to an input periodic signal (input clock) such that there are a precise number of samples of the input signal taken per clock period while at the same time maintaining synchronization with a much longer time period over which the signal repeats (frame period) without having to generate any “trigger” signal at the frame period.

Still other objects and advantages of the invention will in part be obvious and will in part be apparent from the specification and the drawings. 5 The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will also be indicated in the claims.

### BRIEF DESCRIPTION OF THE DRAWINGS

For a more complete understanding of the invention, reference is made to the following description and accompanying drawings, in which:

FIG. 1 depicts a concept of time bin and coherent sampling;

FIG. 2 depicts one example of an incoherent sampling state for PRBS;

FIG. 3 depicts one example of a coherent sampling state for PRBS;

FIG. 4 depicts one example of a coherent interleaved sampling state in accordance with the invention;

FIG. 5 is a block diagram depicting the construction of a system for implementing the coherent interleaved sampling method of the invention;

FIG. 6 is a block diagram depicting a strobe generator with a fractional divider in its input path;

FIG. 7 is a diagram representing a 16ₜₕ th order Stem-Brocot space;

FIG. 8 is a diagram representing a modified 16^{th} th order Stem-Brocot space;

FIGS. 9a-9d present depictions of comparisons of various parameters of a sampling strobe generator constructed in accordance with the invention;

FIG. 10 shows a sampling frequency variation as a function of PRBS clock rate, in accordance with the invention; and

FIG. 11 is a flow chart diagram depicting the steps for determining appropriate sampling, clock and frame periods in accordance with the invention.

### DETAILED DESCRIPTION OF THE PREFERRED EMBODIMENTS

In accordance with the invention, because of a high clock rate and long pattern length of a signal, such as a PRBS (Pseudo Random Bit Stream) used for test/evaluation of communication systems, waveform observation of such a signal becomes very difficult. The Coherent Interleaved Sampling (CIS) architecture proposed in accordance with the invention allows for the acquisition of a complete PRBS waveform, or other long sequenced stream, quickly, uniformly, and repeatedly. Different from sequential or random sampling methods, only the CIS architecture of the invention uses clock input and information indicative of stream length to generate appropriate sampling strobes. The CIS architecture of the invention makes possible the sampling of a PRBS waveform uniformly in time during both a clock period and a frame period.

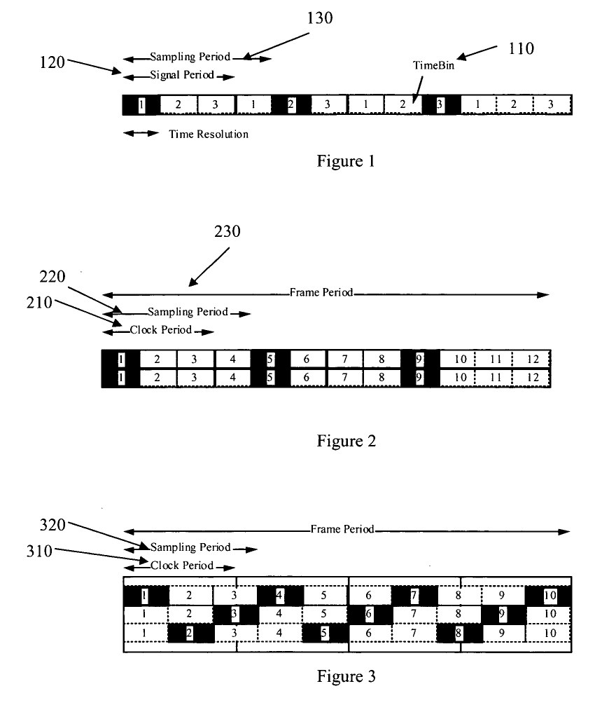

Referring first to FIG. 1, the principle concept of “time bin” will be described, making reference to the results of a system that does not employ the CIS methodology of the present invention. The example of FIG. 1 shows the relation between a time bin 110, a signal period 120, and a sampling period 130 in a coherent sampling scheme, such as that disclosed in the '773 patent noted above. FIG. 1 shows an example of an equivalent time sampling method, which acquires N=3 data samples of a repetitive input waveform uniformly. In FIG. 1, along the time resolution axis, one cycle of the input signal is expressed by time bins 1, 2, and 3. As the signal is repetitive, this set of time bins is repeated (three additional times shown in FIG. 1), allowing for the acquisition of one of the time bins during each pass of the waveform. In this case, time bin length is the same as the time resolution of the equivalent time sampling. For example, if the signal frequency is (1000/3)MHz, then the signal period is 3 nanoseconds. If three pieces of data are acquired from each cycle, the measuring time resolution becomes 1 nanosecond. So there are 3 time bins in one signal period. However, for such a system to operate properly and perform such coherent sampling, the duration of the sampling period should satisfy the following relation of Equation (1):
Tsamplebin=Tsignalbin*(A+N/Tsignalbin), (1)
where Tsamplebin>Tsignalbin, and where Tsamplebin is a number of time bins in a sampling period, Tsignalbin is a umber of time bins in signal period, A is an integer or null, and N/Tsignalbin is an irreducible fraction.

An irreducible fraction plus/minus an integer is also an irreducible fraction. Equation (1) may be rewritten by dividing through by Tsignalbin, as:
Tsamplebin/Tsignalbin=A+N/Tsignalbin
The right side of the rewritten equation is an irreducible fraction plus/minus an integer. Therefore, the above coherent sampling condition can be satisfied, and coherent sampling can be performed, if Tsamplebin and Tsignalbin are relatively prime integers.

In the case shown in FIG. 1, Tsamplebin is 4 and Tsignalbin is 3. As they are relatively prime integers, such a sampling sequence, designated by the noted black rectangular time bins in FIG. 1, satisfies the coherent sampling condition. Waveform data of time-bins #1, #2, and #3 are acquired in three sample periods. In this case, the signal is sampled uniformly in time.

Referring next to FIG. 2, an incoherent sampling state is shown. A clock period 210 corresponds to the duration time of one bit of an NRZ pulse. For a clock rate of 1000/3 MHz, this time interval is 3 nanoseconds. A frame period 230 comprises 4 clock periods, so that the pattern length is 4 and a frame period 230 is 12 nanoseconds. While the clock period 210 of FIG. 2 is same as signal period 120 in FIG. 1, in FIG. 2 only 3 time bins (#1, #5, and #9) are sampled. In this case shown in FIG. 2, Tsamplebin=4 and Tframebin=12, and therefore are not relatively prime integers. Coherent sampling is not performed, and as is shown, the sampling periods repeat rather than progress through the time bins.

Referring next to FIG. 3, an example of another coherent sampling state is shown. (This is not a coherent interleaved sampling scheme such as that presented in accordance with the invention.) In FIG. 3, a clock period 310 is 3 nanoseconds and a frame period 330 has 4 clock periods, so that the pattern length is 4 and the frame period is 12 nanoseconds. This relation is generally the same as in FIG. 2. However a sampling period 320 is changed from 4 nanoseconds to 3.6 nanoseconds. In this case Tsamplebin=3 and Tframebin=10, and are relatively prime integers. Therefore coherent sampling is performed and all 10 time bins are sampled (as in FIG. 1).

Using the values shown in FIG. 3, Equation (1) is expressed as:
10=3*(3+⅓)
Because ⅓is an irreducible fraction, coherent sampling is performed and all time bins are sampled. However the sampled time position of each clock period is not the same. This means that the clock is not sampled uniformly in time. This non-uniform sampling precludes display of the sampled information in a stable, uniform manner. Because the clock is the time reference of the signal, such as a PRBS, it is preferable to acquire data uniformly for each clock period so that the resultant display of the sampled signal is stable.

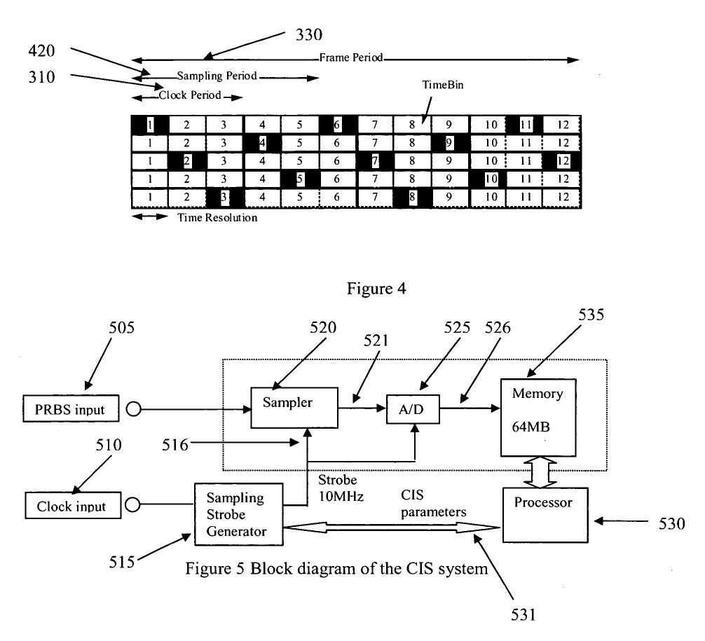

Referring next to FIG. 4, a graph of a sampling scheme in accordance with the CIS system and method presented in accordance with the invention is shown. By restricting a sampling period 420 to 5 ns by way of example in FIG. 4, all frame time bins from #1 to #12 are sampled uniformly. At the same time, each clock duration (#1-#3, #4-#6, #7-#9, and #10-#12) is also sampled uniformly. Finally, while the time bins are sampled out of order, as will be noted below, based upon knowledge of the selected CIS parameters, the samples from the corresponding time bins can be arranged back into their proper sequence.

The differences between the results depicted in FIGS. 2 and 3 and those of FIG. 4 are as follows. In FIG. 2, the frame period (12 time bins) and sampling period (4 time bins) do not satisfy the coherent sampling condition requirements. In FIG. 3 the clock period (2.5 time bins) and the sampling period (3 time bins) do not satisfy the coherent sampling condition requirements. However, in FIG. 4, the sampling period (5 time bins) is a relatively prime integer for both clock period (3 time bins) and frame period (12 time bins), as shown below. In accordance with the invention, this relation is defined as the CIS condition.

Let a signal, such as a PRBS signal, have a pattern length of Lpattern. Then Tframebin is equal to Lpattern*Tclockbin. Therefore, in accordance with the invention, the condition for insuring a CIS performance is defined when Tsamplebin and Lpattem*Tclkbin are relatively prime integers. This relationship may be expressed by Equation (2).
Lpattern*Tclockbin=Tsamplebin*(A+N/Tsamplebin) (2)
where Lpattern*Tclockbin>Tsamplebin, and where N/T samplebin is an irreducible fraction. In the case shown in FIG. 4, we have →4*3=5*(2+⅖), where ⅖is an irreducible fraction.

FIG. 5 shows sampling system which performs CIS processing in accordance with the invention. A clock input signal 510 ranging from a few GHz to a few tens of GHz is input to a strobe generator 515 of the system, and the strobe generator outputs a nominal 10 MHz sampling strobe 516 to a sampler 520 and an ADC 525. The sampling strobe frequency is set so that the CIS conditions noted above are met. This frequency is controlled by information, including CIS parameters 531, sent from a processor 530. The detail of sampling strobe generator 515 will be described below. Sampler 520 samples an instantaneous value of an input PRBS signal 505 in accordance with a received strobe 516. The sampler outputs a sampled signal 521 to ADC 525.

ADC 525 receives both sampled signal 521 from sampler 520 and strobe 516 from strobe generator 515, converts the analog sampled signal 521 to a digital signal 526, and sends the digital signal to a memory 535. Memory 535 receives and stores the digital data 526 of the instantaneous value of input PRBS 505. More than 64 MB of memory capacity is preferable to receive PRBS data for a pattern length of 2²³⁻1 or greater. Once all frame data of the PRBS signal is stored, processor 530 rearranges the waveform based on the information of CIS control parameters 531 to reconstruct the waveform, as noted above.

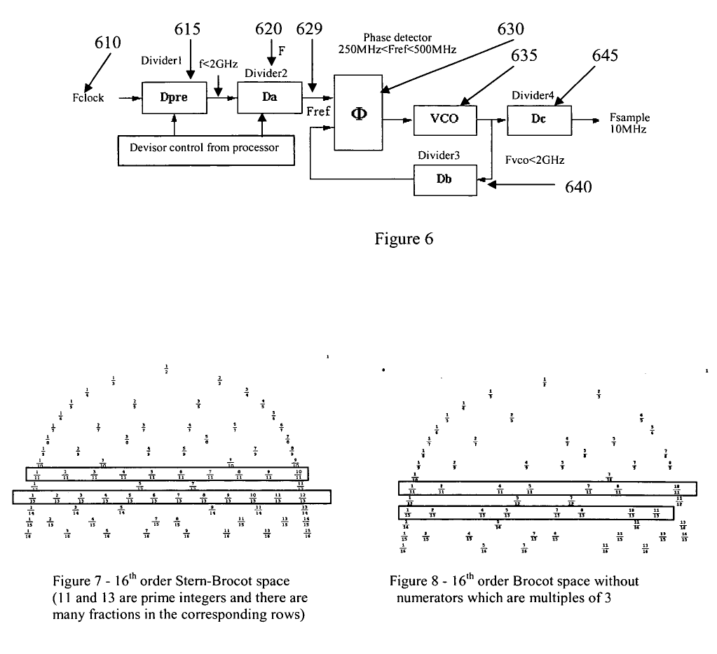

Referring next to FIG. 6, a block diagram depicting CIS sampling strobe generator 515 in accordance with the invention is shown. The construction of such a sampling strobe allows for the precise generation of a sampling pulse nearly exactly correlated with a recovered clock from an input information signal, such as a PRBS. In FIG. 6, a PRBS clock (for example) is input as a reference to a PLL that controls the strobe output so that even if the timing of the PRBS clock fluctuates, the CIS sampling strobe generator always tracks the difference and outputs an exact CIS sampling strobe for performing CIS.

As is noted in the Background of the Invention, maintaining the stability of a sampling frequency within about 10⁻¹¹ MHz of a 10 MHz signal can be quite difficult. If the frame length of the input signal becomes large (such as 2³¹−1) or bit rate (clock rate) becomes low, such as 2 Gbps, this goal becomes even more difficult to achieve. In accordance with the invention, Equation (2) sets the CIS conditions under which such sampling is possible. In accordance with the invention, the size of the CIS sampling time bin should be determined based upon the time of a frame bin, a clock bin and a pattern length of a PRBS signal. The relative relationship among these values is expressed only by integers, and therefore there are no irrational expressions. This means that a sampling strobe signal can be derived from a PRBS's clock signal using frequency dividers. In such a situation, the sampling strobe will be precisely synchronized to a recovered PRBS clock signal. When looking at a signal including a PRBS or other long signal, the time of the frame bin is defined by PRBS, or the time of the other long signal, and is therefore known. The clock is regenerated using an appropriate clock recovery scheme. Therefore it is possible to construct a CIS sampling strobe generator in accordance with the invention that is appropriately synchronized to the input signal.

In FIG. 6, a stable clock signal Fclock 610 is input to a phase detector 630 as an input 629 Fref via a Divider 1 (615) having a divisor of Dpre (an integer value) and a Divider 2 (620) with divisor of Da. The particular values of the divisors are selected in accordance with processing that will be described below, and in concert provide a desired division of the Fclock signal. An output from phase detector 630 is input to a VCO 635. VCO 635 outputs a signal that has a frequency Fvco, which is equal to Dc*Fsample. Dc is a divisor (an integer value) of Divider 4 645. This VCO output is also fed back and input to phase detector 630 via a Divider 3 (640) with divisor of Db. The PLL works so that frequencies and phases of the two signals input into phase detector 630 are maintained to be the same. Therefore a signal passes through FIG. 6 in accordance with Equation (3):
Fref=Fclock/(Dpre*Da)=Fsample*Dc/Db=Fvco/Db (3)
As is evident from this equation, the sample clock is locked to, and is a function of, the input Fclock. As is also evident, selection of the various divisor values allows for definition of the output values of the system. Thus, an Fsample clock very accurately tied to the input Fclock is provided, the relationship between them being defined by the selection of appropriate parameters.

By substituting time bin notation as defined above to frequency notation in Equation (3), Equation (4) is defined as follows:
Tsamplebin=Tclockbin*(Dpre*Da*Dc/Db) (4)
And Tframebin of one PRBS frame is expressed by Equation (5):
Tframebin=Db*Lpattern/(Dpre*Da *Dc)*Tsamplebin (5)
If Da and Db are defined to be fractional, the following relationship for Tsamplebin/ Tclockbin, which is an irreducible fraction, is defined as (after splitting fractions Da and Db into numerator and denominator):
Tsamplebin/Tclockbin=Dpre*Dc *Numerator[Da]*Denominator[Db]/(Denominator[Da]* Numerator[Db]) (6)
Therefore, by arithmetic operation on Equation (6), the following relations are obtained for a CIS relationship as defined in accordance with the invention, between clock signal and sampling strobe signal:
Tclockbin=Numerator[Db]*Denominator[Da] (7)
Tsamplebin=Dpre*Dc*Numerator[Da]*Denominator[Db] (8)
Finally, the CIS constraint as defined above may be expressed as follows in Expression (9):
There is no common factor between Factors of Dpre*Dc*Numerator[Da]*Denominator[Db]] and [The common Factors of Lpattern and of Numerator[Db]*Denominator[Da]] (9)

The implementation of fractional dividers Da and Db, in accordance with an exemplary embodiment of the invention, will now be described. A fractional divider preferably has a divisor of D=(P*D1+Q*D2)/(P+Q), which is between D1 & D2. Values are preferably defined so that D2=D1+1 and P & Q are programmable, so that an increment step of the numerator of D is 1. Then the divisor D of the fractional divider is expressed by Equation (10) as follows:
D1<D=(P*D1+Q*D2)/(P+Q)<D2=D1+1 (10)
Before investigating particular divisors to be used during an implementation of the CIS system in accordance with the invention, particular physical constraints that may be imposed based upon device specifications to be used in a particular embodiment of the system implementing the processes of the invention should be considered. These specifications include at least operating ranges of sampler rate and device speed, a desire to adopt a high Fvco for reducing jitter between Fclock and Fsample, and for having a wide feedback loop bandwidth so that the system is able to properly track any fluctuation in Fclock. Typical constraints in accordance with physical devices that might be implemented in a preferred embodiment of the invention are indicated in FIG. 6, and include a frequency output from divider 615 less than approximately 2 GHz, a reference frequency Fref input to phase detector 630 of between approximately 250 MHz and 500 MHz, a frequency for Fvco output from VCO 635 of less than approximately 2 GHz, and a value for Fsample of approximately 10 MHz.

As a result, in accordance with the preferred embodiment described above, the various values may be selected as follows: Fvco≈1.28 GHz, Dc=128, and Dpre=8, 16 or 32 when Fclock is correspondingly around 10, 20 or 40 GHz. The further constraints on divisors Da and Db include: 3.25<Da<4.4, 2.56<Db<5, and 0.9<Da/Db<1.3. When investigating actual values for the various divisors for implementation, another constraint should be considered, namely that Tclockbin should be defined as constant. (Alternatively, it would be possible to impost the condition that Tsamplebin is constant, or that time resolution (i.e. bin length) be kept as constant as possible.)

If Tclockbin is maintained constant, then the expression (Numerator[Db]*Denominator[Da]) is also defined as being constant (see Equation (7)). Divider 3 becomes an integer divider, and Divider 2 becomes a fractional divider with a constant P+Q in Equation (10). Hereafter P and Q are written as Pa and Qa, which indicates that Da is a fractional divider. As a result, Equations (7) and (8) are re-written as Equations (7′) and (8′).
Tbitbin=Db*Denominator[Da] (7′)
Tclkbin=Dpre*Dc*Numerator[Da] (8′)
For restricting of Fsample variation, one of the fractions is chosen with a denominator of Pa+Qa, which has a lot of numerators irreducible to Pa+Qa. Stern-Brocot space shown in Fig. 7 is a convenient tool for finding a proper Pa+Qa. Its X axis between 0 and 1 corresponds to magnitude of irreducible proper fractions (this case, 16^{th} order Faley series), and its rows (Y direction) correspond to denominators of irreducible fractions.

As a sum of an integer and an irreducible proper fraction is an irreducible mixed fraction with the same denominator as the original irreducible proper fraction, finding a lot of Das is equivalent to finding a lot of Mod[Da,1]s, which is equal to Mod[(Da1Pa+Da2Qa)/(Pa+Qa),1]s. By regarding the X axis in FIG. 7 as Mod[Da,1], the constant Pa+Qa corresponds to one row of FIG. 7. As is shown in FIG. 7, rows that include many distributed fractions between X=0 and 1 are denominators with prime integers, so that a prime integer Kₚᵣᵢₘₑ as Pa+Qa is chosen.

From Equation (8) Tsamplebin is defined as Dpre*Dc*(Da₁Pa+Da₂Qa)=Dpre*Dc*(Da* Kₚᵣᵢₘₑ)=Dpre*Dc*(Da₁* Kₚᵣᵢₘₑ+Qa), where Qa increments by 1 from 0 to Kₚᵣᵢₘₑ. Therefore a variation rate of Tclkbin is almost 1/(Da* Kₚᵣᵢₘₑ). However, factors of (Da₁Pa+Da₂Qa) can include neither Db nor factors thereof, which are listed in Lpattem for performing the coherent sampling or CIS. These numbers must be skipped from the set of available (Da₁Pa+Da₂Qa). FIG. 8 therefore shows a modified Brocot space, in which numerators of multiples of 3 (for an example) are eliminated.

When Fsample variation is small, Da is estimated from Da=Fclock/Fsample*(Db/Dc/Dpre). Therefore 413≦Da*K_{prime≦}597 is obtained for this particular exemplary embodiment (Db=3, Dc=128, Dpre=8, Fclockmin=9 GHz, Fclockmax=13 GHz and Kₚᵣᵢₘₑ=157). The following list shows calculated available (Da₁Pa+Da₂Qa)s.

{416,419,421,422,424,428,431,433,436,439,442,443,446,449,452,454,457,458,461,463 ,464,466,467,472,478,479,481,482,487,488,491,493,494,499,502,503,509,512,514,521, 523,524,526,536,538,541,542,544,547,548,551,554,556,557,559,562,563,566,568,569, 571,577,578,586,587,592,593,596}

The maximum differences between adjacent available (Da₁Pa+Da₂Qa)s is 10 (=536−526). This means that available Da that follows 526/Kₚᵣᵢₘₑ is 536/Kₚᵣᵢₘₑ. And even if Fclock changes, 526/Kₚᵣᵢₘₑ is maintained until 536/Kₚᵣᵢₘₑ becomes a desirable fraction. As a result, Fsample changes according to Fclock change by the rate of 10/526≈2% around Fbit of 11.44 GHz (=10 MHz*526/157*Dc*Dpre/Db).

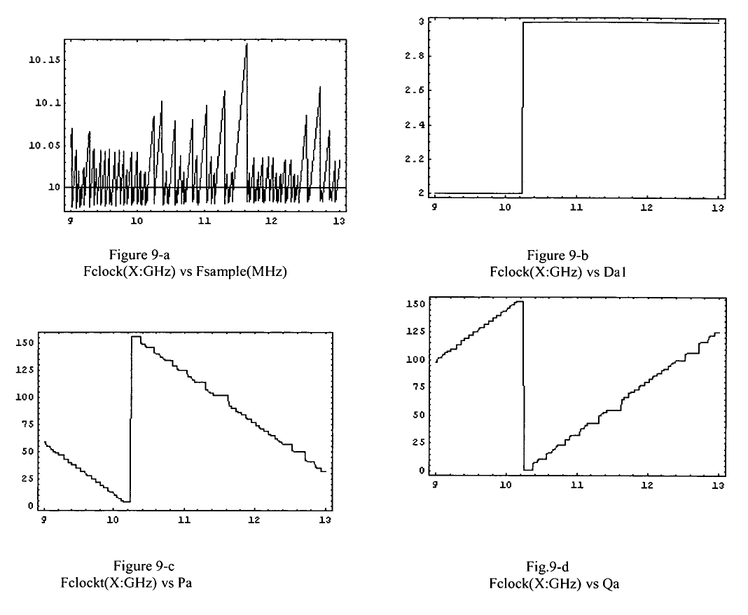

FIG. 9-a shows calculated Fsample vs Fclock as measured in a system employing a strobe generator, such as that described in FIG. 6 and employing the above exemplary parameters. These corresponding parameters are shown in FIGS. 9-b to FIGS. 9-d. FIGS. 9a-9d depict characteristics of such a CIS sampling strobe generator with a fractional divider in its input pass. Fsample variation is approximately less than ±1%.

TABLE 1
Constraints for calculation CIS sampling frequency (Fclk)

| Item | Spec. |
|---|---|
| Input Range of Fbit | 9-13, (18-26), 39-43 |
| (GHz) | |
| Pattern Length | 2⁷ − 1, 2¹⁵ − 1, 2²³ − 1, |
| Time Resolution (ps) | 0.25 ps or less |
| Clock rate (MHz) | Around 10 |

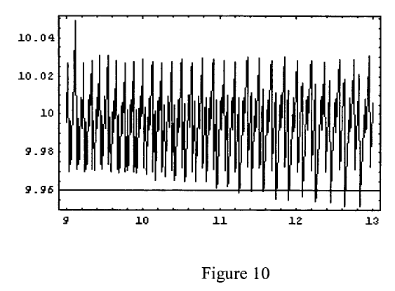

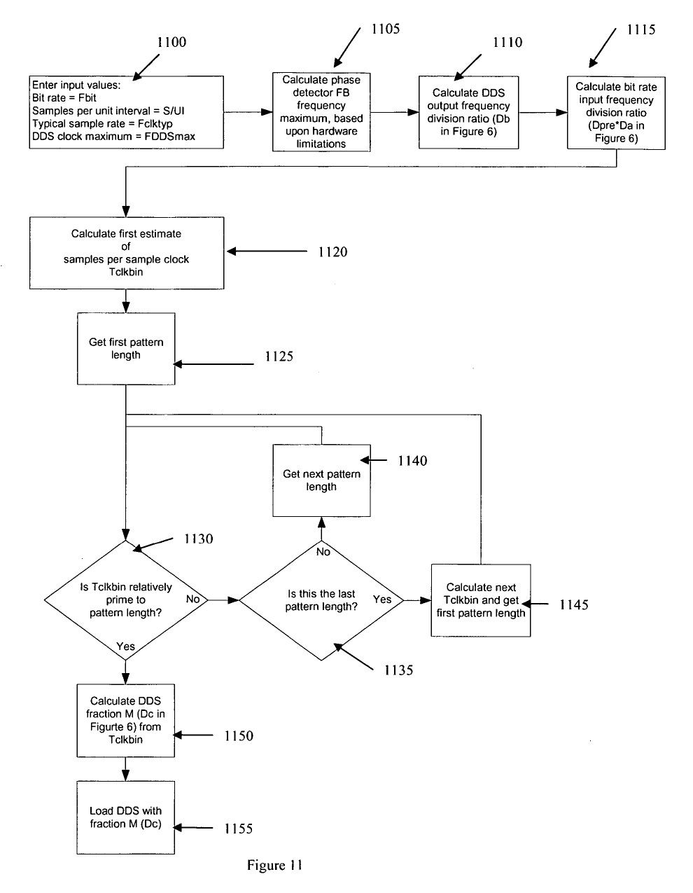

FIG. 10 shows sampling frequency variation about 10 MHz (vertical axis) versus PRBS clock rate in GHz (Fbit, horizontal axis) in a second example of the invention. The various parameters used in this calculation are shown above in Table 1. In this table, the time resolution has been reduced, all other parameters remain the same. As is shown in FIG. 10, variation is limited to almost ±0.5% which is less that that noted in FIG. 9-a. This frequency change in either of these two examples are is so small that the sampler can work as if there is a constant sample rate. This scenario eliminates DC offset or gain change of the sampler that can be caused by a sampling rate change.

FIG. 11 depicts a method for determining the most desirable combination of Lpattern, Tframebin, Lpattern and Tclockbin so that not only is the CIS condition of the invention satisfied, but the most efficient set of parameters is selected so that sampling of the signal is completed most quickly. At step 1100, a user first enters a number of input values to be used in the processing of the invention. These input values include Bit Rate of the signal (Fbit, corresponding to Tclkbin) and Samples per unit interval (S/UI, defining a desired time resolution of the system). Hardware considerations, as noted above, define a number of parameters, including a Typical sample rate (Fclktyp, corresponding to a nominal value of the sample clock output(Fsample in FIG. 6)) and a DDS clock maximum (FDDSmax, based upon a hardware design of Divider 3 in FIG. 6). In accordance with these parameters, at step 1105, a phase detector FB maximum frequency is calculated corresponding to an output from Divider 3 in FIG. 6, at step 1110 a DDS output frequency division ratio is calculated corresponding to divisor Db in FIG. 6, and at step 1115 a bit rate input frequency division ratio, corresponding to Dpre*Da an FIG. 6, is calculated.

After calculation of these variables, at step 1120, a first estimate of samples per sample clock Tclkbin is calculated. Then at step 1125, a first pattern length of a set of possible pattern lengths is retrieved from memory. At step 1130, it is determined whether the calculated Tclkbin is relatively prime as compared with the retrieved pattern length. If this inquiry is answered in the negative, control passes to step 1135 where it is determined whether this is the last available pattern length from the set of possible pattern lengths. If this inquiry is answered in the negative, then at step 1140a next possible pattern length is retrieved and processing passes again to step 1130. If the inquiry at step 1135 is answered in the positive, and it is in fact the last possible pattern length, then processing passes to step 1145, where a new estimate for Tclkbin is calculated, and the first possible pattern length is once again retrieved. Processing then passes back to step 1130.

It is anticipated by the invention that at some point, the inquiry at step 1130 will be answered in the positive, and the tested Tclkbin will be determined to be relatively prime when compared to the currently investigated pattern length. When this inquiry is answered in the affirmative, control passes to step 1150, where a DDS fraction M (Db in FIG. 6) is calculated from the present value of Tclkbin. Then at step 1155 DDS is loaded with the fraction M (Db), thus defining the CIS generating parameters to be used in the sample clock generation system as shown in FIG. 6.

Embodiments of a CIS sampling strobe generator constructed in accordance with the invention are not limited to use a fractional divider. For those skilled in the art, the sampling strobe generator may also be built using a DDS configuration as discussed with respect to FIG. 11.

Implementation of the CIS architecture in accordance with the invention allows for acquisition of a full PRBS waveform. It has, for example, 10000 times faster data acquisition speed than the prior art sampling methods of the '723 and '251 patents. The ability to acquire a PRBS full waveform (or other long waveform) means that a DSO can easily perform post acquisition processing an any acquired data, such as generating averaged eye lines instead of an eye diagram, etc.. The wider the instruments bandwidth, the more noise exists in a data acquisition. Enabling post acquisition processing allows for an increase in measurement accuracy.

Therefore, in accordance with the invention, an acquisition technique in such an under sampled harmonic system can be used to sequentially sample an entire PRBS bit sequence. This sampling can be performed several orders of magnitude faster than equipment available today. If an anomaly or mask error is detected in the eye diagram the CIS technique will permit the specific bit in the sequence to be identified. This capability is extremely valuable to identify, diagnose and correct the pattern dependent errors of a device under test.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description, following claims, and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method for digitizing a repetitive signal having a long pattern length, comprising the steps of:
determining a clock period to be used when sampling the repetitive signal;
determining a frame period of the repetitive signal; and
selecting a sampling period that is a relatively prime integer when compared with the clock period and frame period, the sampling period comprising an integer number of time resolution periods, so that when sampling is performed in accordance with the sampling period, all time resolution periods are sampled at a same relative time position thereof.

2. The method of claim 1, wherein the repetitive signal is a PRBS.

3. The method of claim 1, wherein the time resolution periods are sampled from a plurality of repetitions of the repetitive signal.

4. The method of claim 3, wherein the time resolution periods are sampled in an order other than time sequentially.

5. The method of claim 4, wherein the order is determined in accordance with the relationship between the clock period, the frame period and the sampling period.

6. The method of claim 4, wherein the sampled time resolution periods are placed back in a sequential order.

7. The method of claim 6, wherein the sequentially ordered sampled time resolution periods are displayed on a display.

8. The method of claim 1, wherein the sampling is synchronized to both the frame period and the time resolution periods.

9. An apparatus for digitizing a repetitive signal having a long pattern length, comprising:
an input for receiving a repetitive signal having a long pattern length;
a sampler for sampling the repetitive signal at predetermined time points, the predetermined time points being determined in part by a sampling strobe provided by a sampling strobe generator, the sampling strobe generator comprising:
an input for receiving a clock signal;
a first divider for dividing the clock signal;
a second divider for dividing the output from the first divider;
a phase detector for detecting phase differences from the output from the second divider and the output from a voltage controlled oscillator (VCO) driven by the phase detector, the output from the VCO first being divided by a third divider; and
a fourth divider for dividing the output from the VCO to generate the sampling strobe;
wherein the second and third dividers are fractional dividers; and
wherein the frequency of the sampling strobe is selected so that a sampling period thereof is a relative prime number as compared to a clock period and a frame period of the repetitive signal;
an analog to digital converter for converting each sample of the repetitive signal to a digital representation thereof;
a memory for storing the digital representation of each of the samples; and
a processor for placing the digital representations of each of the samples in a sequential order.

10. The apparatus of claim 9, wherein the samples of the repetitive signal are sampled from a plurality of repetitions of the repetitive signal.

11. The apparatus of claim 10, wherein the samples of the repetitive signal are sampled in an order other than time sequentially.

12. The apparatus of claim 11, wherein the order is determined in accordance with the relationship between the clock period, the frame period and the sampling period.

13. The apparatus of claim 12, wherein the samples are placed back in a sequential order.

14. The apparatus of claim 13, wherein the sequentially ordered samples are displayed on a display.

15. The apparatus of claim 13, wherein a sample timing is synchronized to both the frame period and a time resolution period so that each sample is taken at a similar location within the time resolution period.

16. The apparatus of claim 9, wherein the frequency of the sampling strobe is determined in accordance with the selection of the divisors of the second and third fractional dividers.

17. The apparatus of claim 16, wherein the relationship between the coefficients follow the rule that there is no common factor between:
factors of the coefficient of the first divider times the coefficient of the fourth divider times the numerator of the second divider times the denominator of the third divider; and
the common factors of the long pattern length and the numerator of the third divider times the denominator of the second divider.

18. A method for selecting a sample timing for digitizing a repetitive signal having a long pattern length, comprising the steps of:
(a) determining a first estimate of a number of samples to be taken per sample clock;
(b) selecting a possible pattern length of the repetitive signal;
(c) determining whether the first estimate of the number of samples to be taken per sample clock is relatively prime when compared to the pattern length;
(d) repeating steps (b) and (c) to determine if any possible pattern length meets the condition of step (c);
(e) selecting a next estimate of a number of samples to be taken per sample clock; and
(f) repeating steps (b) through (e) until the condition of step (c) is met;
(g) determining a sample timing in accordance with the selected number of samples to be taken per sample clock and the selected pattern length of the repetitive signal.

19. The method of claim 18, wherein the possible pattern lengths are selected from among a possible set of pattern lengths corresponding to a type of the repetitive signal.

20. The method of claim 18, wherein the number of samples to be taken per sample clock define a sample period, a sampling strobe generator generating a strobe to allow for samples to be taken in accordance with the sampling period.
